(19) United States
(12) Patent Application Publication
(10) Pub. No.: US 2019/0022430 A1
(43) Pub. Date: Jan. 24, 2019

(54) Firefighter Self Contained Breathing Apparatus (SCBA) Pack With Integrated Rescue Equipment

(71) Applicant: E.S. Safety Systems Inc., Ashburn (CA)

(72) Inventor: Richard L. Denike, Ashburn (CA)

(21) Appl. No.: 16/137,165

(22) Filed: Sep. 20, 2018

Related U.S. Application Data
(63) Continuation-in-part of application No. 15/347,455, filed on Nov. 9, 2016, now abandoned.
(60) Provisional application No. 62/337,639, filed on May 17, 2016.
(60) Provisional application No. 62/252,714, filed on Nov. 9, 2015.

(51) Int. Cl. A62B 1/06; A62B 25/00; B66D 1/12; A62B 1/18; A62B 9/04; B66D 1/60

(52) U.S. Cl. CPC A62B 1/06; A62B 25/00; B66D 1/12; B66D 2700/0141; A62B 9/04; B66D 1/60; A62B 1/18

(57) ABSTRACT

An improved firefighter SCBA harness is provided. The harness has a backplate for supporting an air cylinder. A waist belt extends from the backplate to secure the backplate to a waist of a firefighter wearing the SCBA harness. Shoulder straps extend from a top of the backplate connecting to the waist belt. A seat harness extends from a bottom of the backplate to a front of the waist belt for positioning through the legs of a firefighter. A bailout cable kits provides a spool on the waist belt for extending a cable from the harness to enable the firefighter to perform a bailout, used in a retrieval or as a fall restraint. A battery powered winch may also be integrated in the harness.

### CROSS-REFERENCE TO RELATED APPLICATIONS

This application claims priority from U.S. Provisional Application No. 62/252,714 filed Nov. 9, 2015 and U.S. Provisional Application No.

62/337,639 filed May 17, 2016, and is a continuation-in-part of U.S. non-Provisional application Ser. No. 15/347,455 filed Nov. 9, 2016 the entirety of each application is hereby incorporated by reference for all purposes.

### TECHNICAL FIELD

The present disclosure relates to firefighter rescue and in particular to self- contained breathing apparatus harnesses.

### BACKGROUND

Firefighters need to have equipment available to facilitate emergency egress from a building or structure. Firefighters are required to carry various equipment packs such as a firefighter personal bailout kit, a rapid intervention team (RIT) retrieval kit, and a fall restraint kit. A typical bailout kit comprises rope that connects to a waist belt or harness worn by a firefighter to enable egress from a building for example through a window whereas RIT retrieval kit and fall restraint require additional harness and attachment points to be worn by the firefighter. The additional hardware required can be cumbersome and difficult to operate when used in conjunction with firefighter Personal Protective Equipment (PPE). Therefore there is a need for an improved firefighter apparatus integrating a retractable firefighter bailout kit, a rapid intervention team (RIT) retrieval kit, and a fall restraint kit.

Current solutions utilize life safety ropes which are not designed for the Fire Service industry or for integration in PPE equipment. The solutions provided in the art do not account for integration with firefighter PPE and therefore do not provide a means of operations that useful in the Fire Service industry.

### BRIEF DESCRIPTION OF THE DRAWINGS

Further features and advantages of the present disclosure will become apparent from the following detailed description, taken in combination with the appended drawings, in which:

FIG. 1 shows a representation of self-contained breathing apparatus (SCBA) harness;

FIG. 2 shows a front view of an improved SCBA harness having an integrated retractable bailout kit;

FIG. 3 shows a back view of the improved SCBA harness having an integrated retractable bailout kit; and

FIG. 4 shows a representation of the improved SCBA harness in operation.

It will be noted that throughout the appended drawings, like features are identified by like reference numerals.

### DETAILED DESCRIPTION

In accordance with an aspect there is provided a firefighter SCBA harness comprising: a backplate for supporting an air cylinder on a back of a firefighter; a waist belt extending from the backplate to secure the backplate to a waist of the firefighter wearing the SCBA harness; shoulder straps extending from a top of the backplate connecting to the waist belt; a seat harness extending from a bottom length of the backplate to a front of the waist belt for positioning through legs of the firefighter to a central portion of the waist belt; and a bailout kit on a central portion of the waist belt for extending a cable to be spooled from the firefighter SCBA harness to enable the firefighter to descend using the SCBA harness when the bailout kit is activated by an actuation button contained thereon.

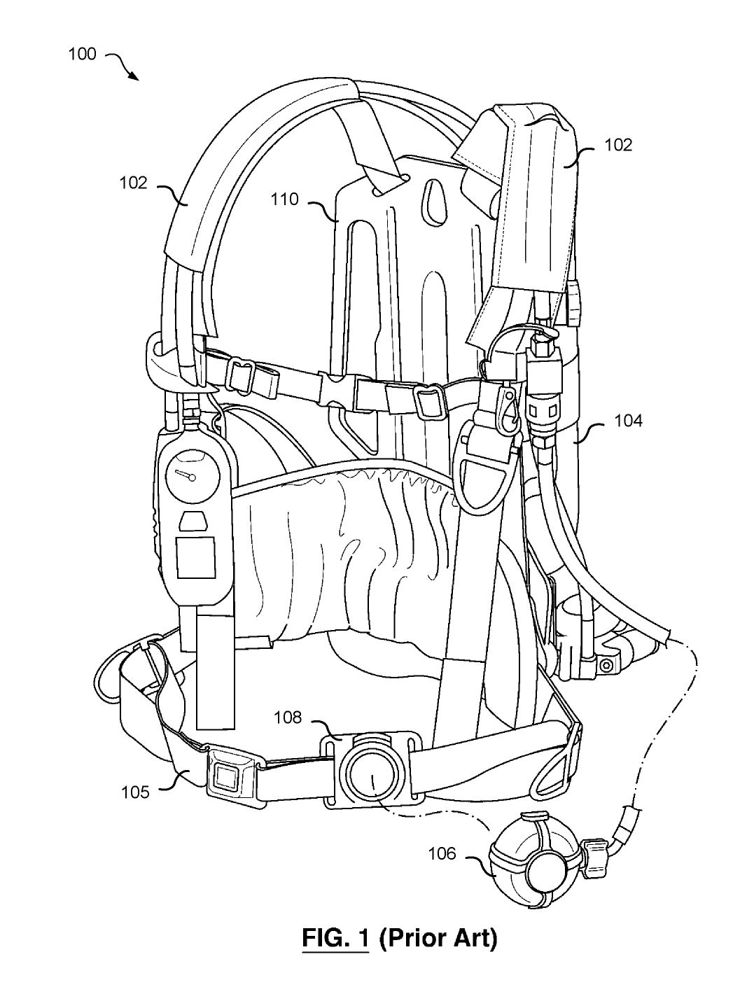

The invention will now be described in detail with reference to various embodiments thereof as illustrated in the accompanying drawings. Specific details are set forth in order to provide a thorough understanding of the invention. It will be apparent to one skilled in the art that the invention may be practiced without using some of the implementation details set forth herein. It should also be understood that well known operations have not been described in detail in order to not unnecessarily obscure the invention. Embodiments are described below, by way of example only, with reference to FIGS. 1-4.

FIG. 1 shows a representation of self-contained breathing apparatus (SCBA) harness 100. The harness 100 has shoulder straps 102 which support an air bottle 104 on a backplate 110. A waist strap 105 has a receiver 108 for holding the regulator 106. The SCBA harness 100 is worn on top of a firefighters PPE. Additional equipment such as a bailout bag containing a rope to enable descents in emergency situations must be carried by the firefighter. For bailout, rapid intervention team (RIT) retrieval, and fall restraint situations separate equipment must be worn by the firefighter in addition to the breathing apparatus. The additional equipment can be cumbersome and difficult to manage. The present invention provides a bailout kit solution more exclusively for emergency services applications which integrates with existing Fire Fighters personal protection equipment without requiring a duffle bag of gear to be handled.

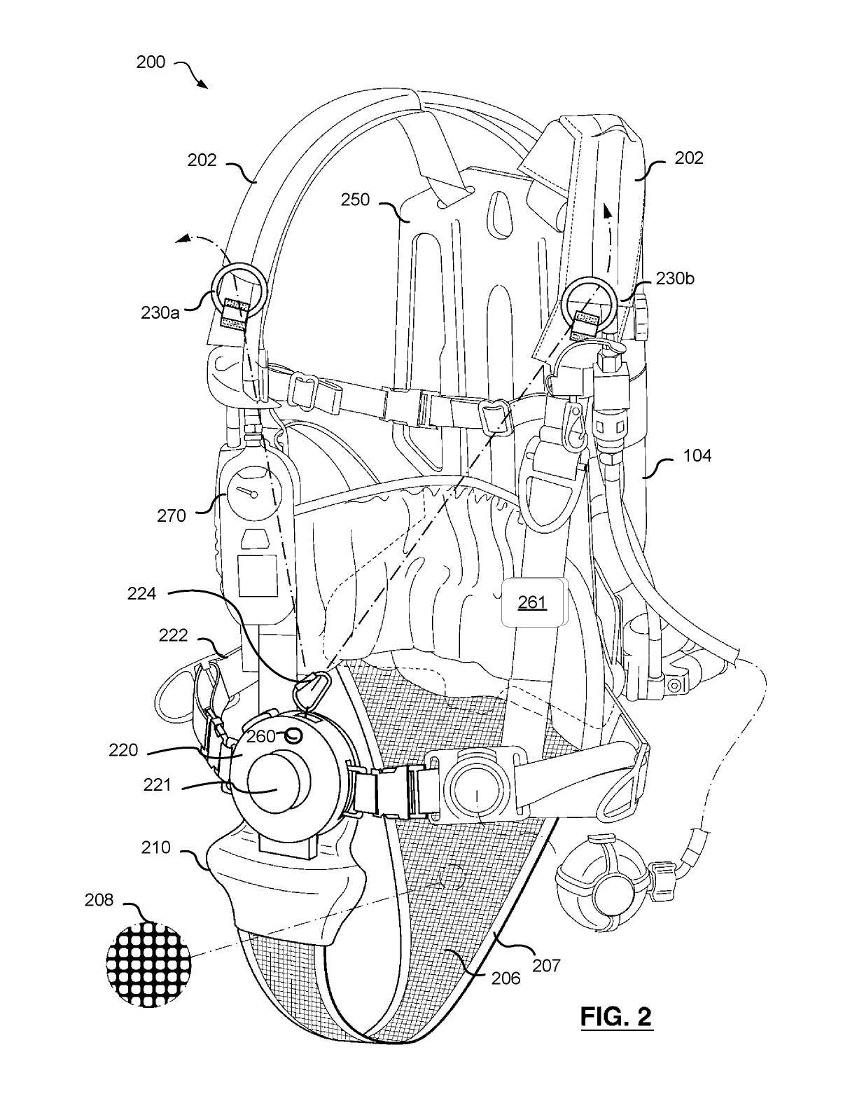

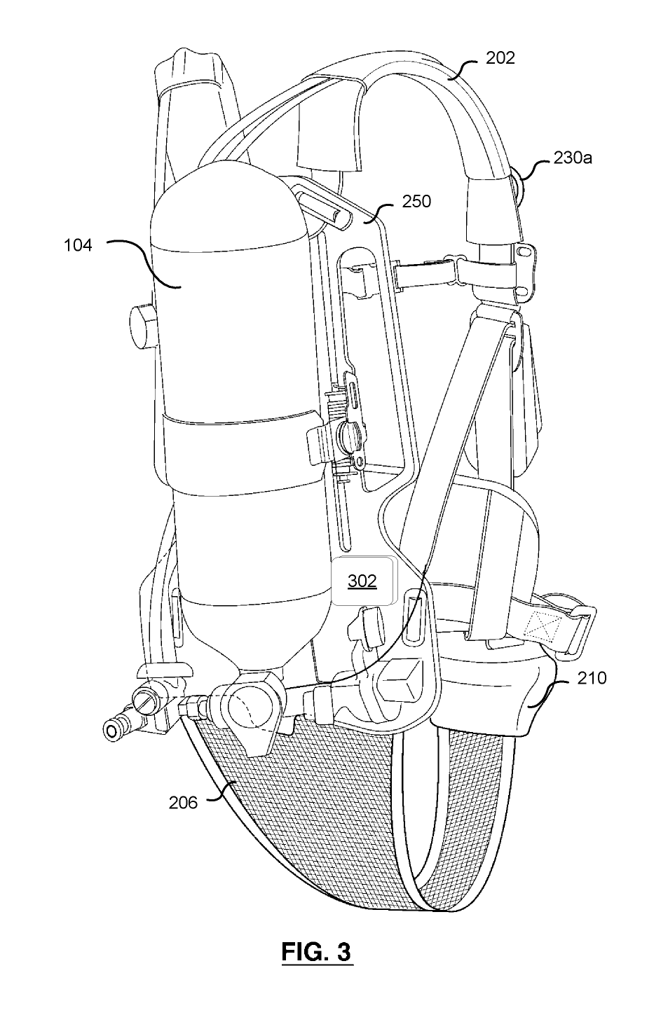

Referring to FIGS. 2 and 3 respectively show a front view and a back view of an improved SCBA harness 200 having an integrated retractable bailout kit 220. The waist strap or waist belt 222 has a bailout kit 220 with an actuator button 221 for releasing the cable in a controlled matter from the bailout cable spool contained therein. The bailout kit is located centrally on the belt of the SCBA harness and make be integrated with a buckle to secure the harness. The bailout cable extends from the top of the bailout kit 220 has a carabiner 224 for securing the cable of the bailout cable spool when performing an emergency egress. The cable is a lightweight metal cable or wire rope, such as aircraft cable sufficient for supporting the weight of a firefighter. The cable is of sufficient lengths to descend from 30 feet but may go up to 100 feet if required. A seat harness 206 extends from the bottom backplate 250 connects to the front waist strap 105 with connector 210 through the legs of a firefighter. The shoulder straps 202 have respective integrated O-rings, or loops, 230a and 230b for guiding the bailout cable from the cable spool of the bailout kit. The harness structure 206 may be reinforced with a cable structure 207 or made of a high strength material running there through. The seat harness 206, or bib, can be made of a mesh material 208 to allow flexibility and movement. The seat harness may alternatively be made of flat reinforced straps. In addition the SCBA harness may include a battery powered winch device to enable the firefighter to ascend to an anchor point which may be required when a slip or fall occurs from a higher point. The winch device can be integrated with the bailout cable spool 220 or maybe provided by a separated spool. The battery 302 for the bailout kit can be integrated into the backplate 250 or attached to the waist strap 222 or a shoulder strap with a power cable connected to the bailout kit 220. The cable from the winch can feed through O-rings 230a and 230b to feed the cable to an anchor point. Controls for the winch can be integrated with control console with remote pressure gauge 270 or positioned on the winch device to control ascent or descent of the firefigher. The bailout cable spool winch may further include a wireless communication system 261 or provide a trigger to communicate with a wireless communication system. The wireless communication system can be integrated with the bailout kit 220, or remote from the bailout kit 220 and connected by a wireless interface. Alternatively the wireless communication interface may be integrated with a detachable radio system such as a walkie-talkie or cellphone device. The wireless communication interface provides a radio transceiver, processor and memory which process input and execute commands to send communications when events occur related to the harness. When the bailout cable spool or an associated winch provided by the bailout cable spool is activated a notification is generated to advise on site command of the status of the firefighter and may provide telemetry information as to the state of the harness, spool or winch. The spool or winch can integrate a sensor 260 which is coupled to a communication interface. The sensor 260 determines that state of the spool or winch 220. Further the activation of the bailout kit may be provided remotely through the communication interface if for example the firefighter is incapacitated. An intermediary device such as a radio or mobile phone may be utilized to pair with the communication interface of the spool or winch or the communication interface may be integrated with the remote pressure gauge 270 control. The communication interface may be a short range communication personal network interface such as Bluetooth™, fire service radio system, public safety mobile broadband, a medium range network interface such as Wi-Fi or a long range mobile network interface such as for example 3G, Long-term evolution (LTE) or 5G or a combination therein.

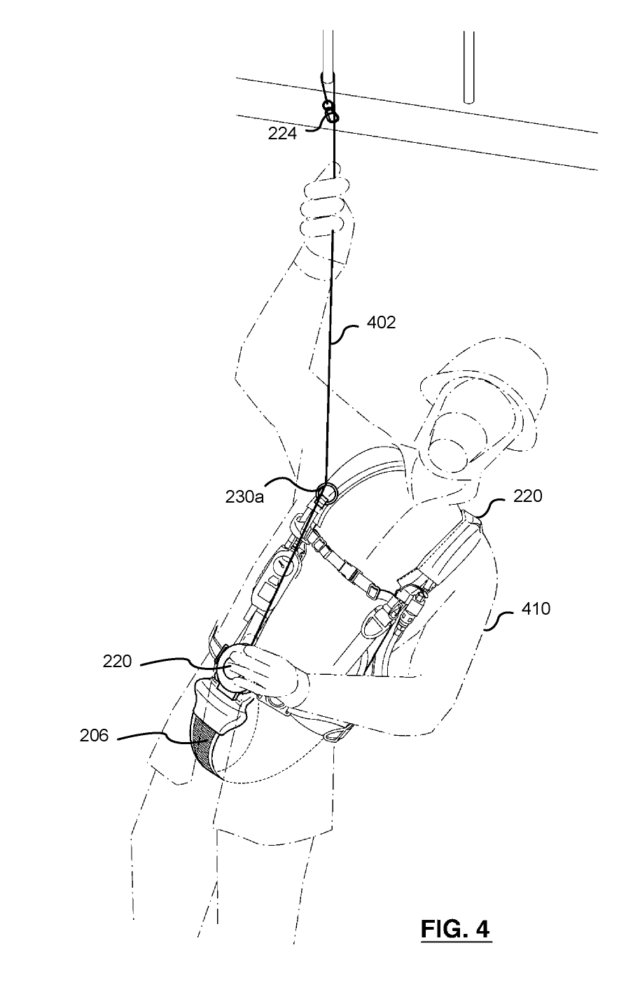

FIG. 4 shows a representation of the improved SCBA harness in operation. A cable 402 connected to the carabiner 224 can be connected around a securing point for lowering the firefighter 410 to safety. The cable 402 extends through the O-ring 230a of the harness 200. The firefighter 410 can control the descent rate by pressing the actuator button 221 on the spool of the bailout kit 220 to release or play out the cable 402 in a controlled manner during a descent. The bailout kit 220 can also provide a battery powered winch function to also allow the firefighter to ascend to the anchor point. The rescue of a down firefighter is something that is trained on regularly. The improved SCBA harness allows the ability to remove a firefighter from the hazardous environment as quickly as possible determines survivability. Being able to descend them on their own life line from heights (roof, ladders, elevated platforms, windows) as opposed to carrying them out greatly speeds the process, and improves survivability. In addition in an embodiment the SCBA harness enables the firefighter to ascend back to an anchor point using a winch function when a slip or fall occurs. The operation of the bailout kit 220 from a descending to ascending function can be controlled via an operation switch located on the bailout kit 220 body.

It would be appreciated by one of ordinary skill in the art that the system and components shown in FIGS. 1-4 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A firefighter SCBA harness comprising:
a backplate for supporting an air cylinder on a back of a firefighter;
a waist belt extending from the backplate to secure the backplate to a waist of the firefighter wearing the SCBA harness;
shoulder straps extending from a top of the backplate connecting to the waist belt;
a seat harness extending from a bottom length of the backplate to a front of the waist belt for positioning through legs of the firefighter to a central portion of the waist belt; and
a bailout kit on a central portion of the waist belt for extending a cable to be spooled from the firefighter SCBA harness to enable the firefighter to descend using the SCBA harness when the bailout kit is activated by an actuation button contained thereon.

2. The firefighter SCBA harness of claim 1 wherein one of the shoulder straps has an O-ring for guiding the cable upwards to be secured to a structure when performing a bailout procedure from a building structure.

3. The firefighter SCBA harness of claim 1 wherein the seat harness is made of a mesh material.

4. The firefighter SCBA harness of claim 3 wherein the seat harness has one or more reinforcing cables extending from the backplate to the waist belt.

5. The firefighter SCBA harness of claim 2 wherein the seat harness has one or more reinforcing cables extending from the backplate to the waist belt.

6. The firefighter SCBA harness of claim 1 wherein the bailout kit further provides a winch function to enable ascents using the cable.

7. The firefighter SCBA harness of claim 6 wherein the winch is part of the bailout kit, wherein the cable can be spooled out or winched into the bailout kit.

8. The firefighter SCBA harness of claim 6 wherein the winch is battery powered.

9. The firefighter SCBA harness of claim 8 wherein the battery is integrated in the backplate.

10. The firefighter SCBA harness of claim 8 wherein the battery is attached to the waist belt or shoulder strap.

11. The firefighter SCBA harness of claim 1 further comprising a sensor coupled to the bailout kit, the sensor detecting operation of the bailout kit.

12. The firefighter SCBA harness of claim 11 wherein the sensor is coupled to a wireless communication interface for providing a notification to a remote device when the bailout kit is operated by the firefighter.

13. The firefighter SCBA harness of claim 1 wherein the seat harness connects to the bailout cable spool on the waist belt.

14. The firefighter SCBA harness of claim 1 wherein the cable has a carabiner connected thereon.

15. The firefighter SCBA harness of claim 1 wherein the rate of descent is controlled by the actuation button.

16. The firefighter SCBA harness of claim 1 wherein the actuation button provides a slow descent mode when can be activated and without requiring constant force input.
